(19) United States
(12) Patent Application Publication
(10) Pub. No.: US 2011/0027053 A1
(43) Pub. Date: Feb. 3, 2011

(54) METHOD AND WAREHOUSE SYSTEM FOR FEEDING SUPPLY GOODS TO A DESTINATION STORAGE, PREFERABLY A HIGH-BAY WAREHOUSE AREA OF A PICKING SYSTEM

(76) Inventor: Karl Freudelsperger, Hart bei Graz (AT)

Correspondence Address: MCGLEW & TUTTLE, PC, P.O. BOX 9227, SCARBOROUGH STATION, SCARBOROUGH, NY, 10510-9227, US

(21) Appl. No.: 12/934,726

(22) PCT Filed: May 11, 2009
(86) PCT No.: PCT/EP2009/003314

§ 371 Date: Sep. 27, 2010

(30) Foreign Application Priority Data
May 27, 2008 (DE) 102008025227127

(51) Int. Cl. B65G 1/137; B65G 1/04; B65G 47/51

(52) U.S. Cl. 414/273; 414/807; 414/267

(57) ABSTRACT

A method and warehouse system for feeding supply goods in the form of packages, containers, cartons, single and/or bundled goods from a feeding station via a feeding section (4) to a destination storage (6) or a storage control station of the destination storage (6), preferably a high-bay warehouse area of a picking system, includes an intermediate buffer system (10) having a reversibly driven intermediate buffer (3). The intermediate buffer system (10) receives the supply goods during or in anticipation of a stock overload at the destination storage (6) during the time of the feeding process, and after a stock overload or following an impending stock overload releases said supply goods to the destination storage (6).

### CROSS REFERENCE TO RELATED APPLICATIONS

This application is a United States National Phase application of International Application PCT/EP2009/003314 and claims the benefit of priority under 35 U.S.C. §119 of German Patent Application DE 10 2008 025 227.1 filed May 27, 2008, the entire contents of which are incorporated herein by reference.

### FIELD OF THE INVENTION

The present invention pertains to a process and to a storage system for feeding products to be loaded in the form of packing drums, containers, boxes, individually packed and/or bundled products from a feed station via a feed section to a destination storage area or to a bay storage and retrieval unit of the destination storage area, preferably of a high-shelf storage area in a commissioning unit (a picking system).

### BACKGROUND OF THE INVENTION

As is known, products are delivered by trucks in the goods receiving area of commissioning units and they are usually repacked into transport containers, which are transported over stationary delivery sections or rail-borne auxiliary vehicles to a bay storage and retrieval unit of the high-shelf storage area and are transferred to the bay storage and retrieval unit for loading. The bay storage and retrieval unit then loads the transport containers loaded with products into the high-shelf storage area and has a certain peak throughput for this. To prevent congestion from developing, the loading capacity of the bay storage and retrieval units can be designed for the peak load. If the loading capacity is increased by the repacking stations, a plurality of bay storage and retrieval units are used according to the state of the art, which process the repacked transport containers without the development of congestion. However, additional bay storage and retrieval units are expensive and are suitable mainly for high-shelf storage areas with a plurality of storage aisles and less so for high-shelf storage areas of medium to small storage capacity or loading and unloading frequency.

### SUMMARY OF THE INVENTION

The object of the present invention is to provide a process and a storage system, which makes possible, with a simple design, a reliable and comparatively rapid loading of the products to be loaded at the destination storage area itself with the use of only a single storage area storage and retrieval unit even during peak times during which increased amounts of products to be loaded are being delivered to the goods receiving and without the development of congestion at the goods receiving.

The essence of the present invention is that a buffering system with a reversibly drivable buffer picks up the products to be loaded during or in anticipation of an overload in the destination storage area during the time period of feeding and releases it again to the destination storage area after an overload or after the end of the risk of overload. In particular, the buffering system picks up the products to be loaded during or in anticipation of an overload in the destination storage area fully automatically or at least partly automatically in an ordered and defined manner and again releases the buffered products to be loaded to the destination storage area or to the storage area storage and retrieval unit of the destination storage area fully or at least partly automatically in a defined manner corresponding to a selected logistic feed strategy.

The buffer may be a horizontal, linear or closed buffering section arranged close to the floor or overhead, preferably an accumulating chain conveyor or an accumulating roller conveyor.

The buffer may also be a reversible vertical conveyor, a reversible paternoster or a reversible spiral conveyor.

A decision station arranged in the feed section preferably assigns the products to be loaded to the buffering system during or in anticipation of an overload of the destination storage area.

In particular, the product to be loaded is palletized in a palletizing/depalletizing station before being picked up in a buffer of the buffering system and is again depalletized after buffering in the buffer before being released to the destination storage area.

Consequently, the product to be loaded being buffered at the buffer is fed automatically via the depalletizing system of the buffering system to the destination storage area in case of a load-specific storage capacity, i.e., in case of sufficient storage capacity of the destination storage area.

A higher-level control and warehouse management system, which operates or actuates the decision station, is preferably provided.

The decision station recognizes the products to be loaded by tracking the product to be loaded or container or by identification based on the load of the destination storage area.

In particular, feeding from the buffering system to the destination storage area is provided, during which selection of products to be loaded, which are needed in a prioritized manner, is still made possible via a decision station arranged downstream.

However, the products to be loaded, which are needed in a prioritized manner, may also have already been recognized at the decision station and fed directly to the destination storage area.

The process according to the present invention describes the temporary buffering of products to be loaded, i.e., of packing drums, containers, boxes, individually packaged and bundled products in case of overload of a primary storage site defined as a destination site, preferably of a high-shelf storage area, during loading.

The system comprises a feeding area, preferably the goods receiving area, a decision station, the primary destination storage area and the buffering system.

If, for example, packing drums which are removed from the goods receiving area and are intended for the primary destination, are fed, and the primary destination is being overloaded in the time period of feeding, the packing drums are fed to the buffering system via the decision station in order to be buffered there for the needed time period.

The buffer may have various fully automatic (partly automatic) designs; in particular, a palletizing and depalletizing system is provided. This comprises an empty pallet magazine, a palletizing and depalletizing unit and pallet buffering sections.

The products fed to the buffer are preferably fed to an empty pallet, which acts as a carrier system and is separated from the empty pallet magazine, in case a palletizing and depalletizing system is used, and buffered on the buffering section.

The design embodiments of the buffering sections permit all logistic variants of loading and retrieval strategies (e.g., FIFO—first in, first out; or LIFO—last in, first out).

The products being buffered at the buffer are automatically fed via the depalletizing system to the section for the primary target site in case of load-specific storage capacity, i.e., in case of sufficient storage capacity of the primary destination buffer.

A special advantage of the present invention is that products to be loaded can be loaded even into smaller to medium-sized high-shelf storage areas, which may possibly have only a single bay storage and retrieval unit, without the development of congestion at the goods receiving even during peak delivery times. Since the loading of the products to be loaded into the system takes place without the development of congestion at the goods receiving, i.e., without waiting time, the product to be loaded is known to the central computer or to the higher-level control and warehouse system without time delay and can correspondingly be managed and also directed in a timely manner or in an up-to-date manner.

Further advantages and details of the present invention will be described in more detail below on the basis of exemplary embodiments with reference to the drawings attached; in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram of the system for feeding products to be loaded to a high-shelf storage area with a buffering system according to the present invention;

FIG. 2 is a schematic side view of a buffering system for stackable products to be loaded with a layer palletizer;

FIG. 3 is a schematic top view of a buffering system for stackable products to be loaded with a layer palletizer; and

FIG. 4 is a schematic perspective view of a buffering system for stackable products to be loaded with a layer palletizer.

### DESCRIPTION OF THE PREFERRED EMBODIMENTS

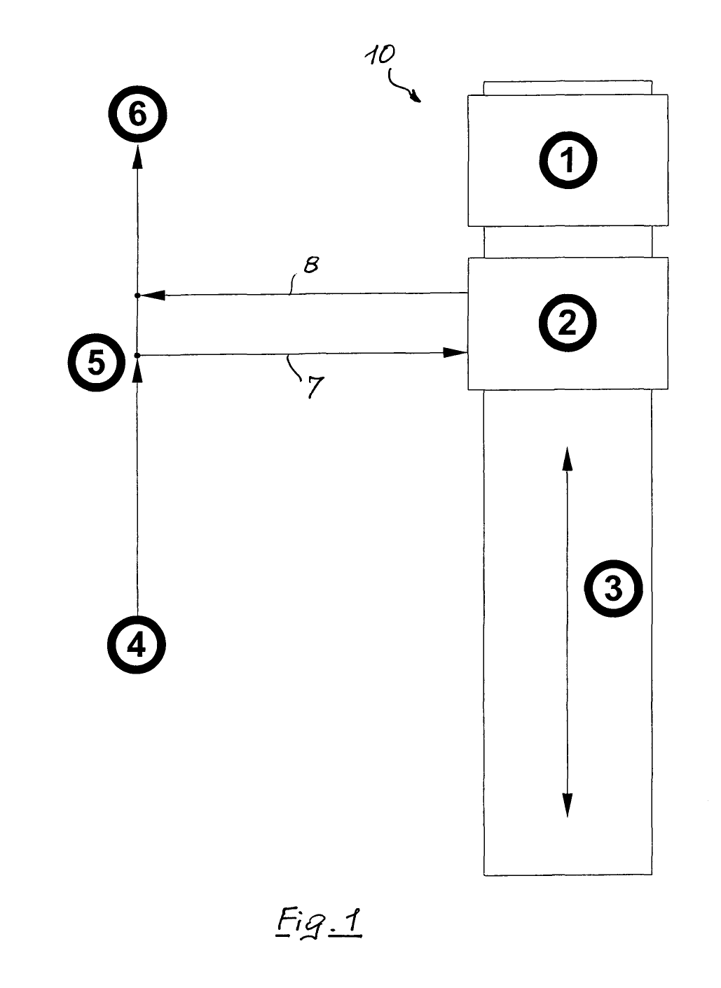

Referring to the drawings in particular, according to a schematic diagram in FIG. 1, the temporary buffering of products to be loaded 11 in the form of packing drums is shown in a buffering system 10 in case of overload of a high-shelf storage area 6 of a commissioning unit, which said high-shelf storage area is defined as a destination site.

The system comprises a feed section 4 in the form of a conveying system, e.g., driven accumulating roller conveyor, chain conveyor or conveyor belt, which is preceded by a goods receiving area, not shown. The goods receiving area is approached by trucks. The products are unloaded, repacked into transport containers, and the repacked transport containers loaded with products, namely, the products to be loaded are loaded into the system at the goods receiving immediately without the development of congestion even during peak times during which increased amounts of product are being delivered and conveyed on the driven conveying means in the direction of high-shelf storage area 6.

A decision station 5 is located in the feed section 4 leading to the high-shelf storage area 6, and said decision station 5 assigns the products to be loaded 11 to the buffering system 10 during or in anticipation of an overload of the high-shelf storage area, i.e., when a threshold value (e.g., 97%) of a full load capacity of a bay storage and retrieval unit or of the bay storage and retrieval unit is reached during loading into the high-shelf storage area during the time period of feeding of products to be loaded on the feed section 4.

Based on the full load capacity of the high-shelf storage area 6, the decision station 5 recognizes the product to be loaded 11 by tracking the packing drums or by identification. It is obvious that the product to be loaded is sufficiently labeled, for example, by bar code or transponder, i.e., it is identifiable.

Recognition may take place, for example, such that the product to be loaded 11, provided with a transponder, is conveyed through a scan tunnel with transmitting antenna and receiving antenna and is automatically recognized in the process by a control/receiving unit connected to a higher-level control computer and is subsequently processed further by control actions of the higher-level control computer, which is the central computer of the system.

When a settable threshold value (e.g., 97%) of the full load capacity of the high-shelf storage area is reached in the exemplary embodiment shown in the drawings in the time period of feeding, the product to be loaded 11 is no longer fed directly to the high-shelf storage area 6, but is pushed at the decision station 5, via a discharging means, not shown, e.g., a cross pusher, onto a transversely running, driven conveying section 7 in the form of another conveyor belt and is fed from there to the buffering system 10 in order to buffer the product to be loaded 11 there for the needed time period.

The buffer may have various fully automatic (partly automatic) designs. A palletizing and depalletizing system is preferably provided. This comprises an empty pallet magazine 1, a palletizing and depalletizing unit 2 and empty pallet buffering sections 9.

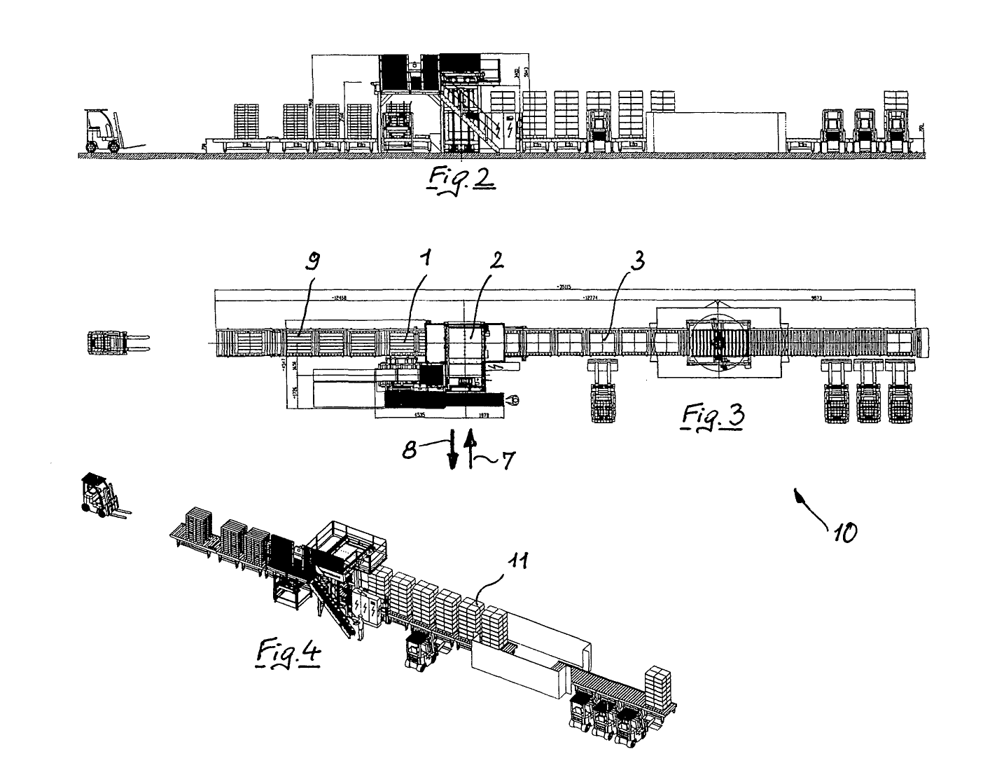

The product to be loaded 11, which is fed to the buffering system 10, is preferably fed, in case of using a palletizing and depalletizing system, to an empty pallet, which is separated from the empty pallet magazine 1, and which acts as a carrier system, and is buffered on the buffer 3 proper in the form of a buffering section. Such a palletizing/depalletizing system is schematically illustrated as an example in FIGS. 2 through 4 in the form of a layer palletizer.

The design embodiments of the buffering sections permit all logistic variants of loading and retrieval strategies (e.g., FIFO—first in, first out; or LIFO—last in, first out).

In case of load-specific storage capacity, i.e., in case of sufficient storage capacity of the high-shelf storage area, the products being buffered at buffer 3 are fed automatically to the high-shelf storage area 6 via the depalletizing system and the further conveying section 8, which opens again into the feed section 4 after decision station 5.

The buffer system 10 is provided with a reversibly drivable buffer 3, which is, according to the drawings, a horizontal buffering section arranged close to the floor or overhead, preferably an accumulating chain conveyor.

Buffer 3 may be a linear or closed buffering section.

However, buffering section 3 may also be a reversible vertical conveyor, a circulating paternoster or a reversible spiral conveyor.

In particular, buffering system 10 is designed for stackable products to be loaded.

The buffering system 10 may also be able to be operated via an articulated arm robot.

The two conveying sections 7 and 8 connected to the feed section 4 to and from the buffering system 10 preferably extend in parallel to one another, conveying section 7 being connected to the decision station 5 and intended for removing products to be loaded to the buffering system 10, whereas conveying section 8 opens into the feed section 4 after the decision station 5 and is intended for returning the buffered products to be loaded 11 to the destination storage area 6.

Buffering system 10 may be connected to feed section 4 via a single, reversible conveying section instead of to the two non-reversible, preferably parallel conveying sections 7 and 8.

According to the exemplary embodiment, the destination storage area 6 may also be a rotary storage unit or a freely movable or rail-borne storage or bay storage and retrieval unit for the high-shelf storage area or rotary storage unit.

Destination storage area 6 may also be a shipping warehouse, in which case the buffering system 10 acts as a shipping buffer in case of out-of-balance load between different shipping areas.

Buffering system 10 may also have stacking machines, which are column stackers in terms of their system and are able, in principle, to stack a plurality of types of packing drums.

During operation, the stacking machine grips a packing drum or a partial stack of packing drums and lifts up the packing drum or partial stack of packing drums. A next packing drum or a next partial stack of packing drums, of, for example, a different height, moves into the machine. The machine places the lifted stack onto the introduced stack, repositions itself and grips both stacks and lifts up both. Another stack of, for example, yet another height is now moving in. The operation is repeated until a tower of a defined height has formed.

Unstacking takes place correspondingly in the reverse order to feed again a single packing drum or a partial stack of packing drums of a desired height via the conveying section 8 to the destination storage area 6, for example, in the form of a high-shelf storage area.

The above-mentioned buffering system 10 is capable of picking up the product to be loaded fully automatically or at least partly automatically in an ordered and defined manner during or in anticipation of an overload in the destination storage area during the time period of feeding and to again release the product to be loaded being buffered fully or at least partly automatically in a defined manner to the destination storage area or to the storage area storage and retrieval unit of the destination storage area corresponding to a selected logistic feeding strategy when the load-specific storage capacity, i.e., a sufficient storage capacity of the destination storage area is restored.

The overall control and warehouse management take place via a higher-level control and warehouse management system.

While specific embodiments of the invention have been described in detail to illustrate the application of the principles of the invention, it will be understood that the invention may be embodied otherwise without departing from such principles.

1. A process for feeding products to be loaded in the form of packing drums, containers, boxes, individually packed and/or bundled products, the process comprising the steps of:
feeding the products to be loaded from a feed station via a feed section to a destination storage area or to a storage area storage and retrieval unit of the destination storage area or a high-shelf storage area in a commissioning unit;
providing a buffering system with a reversibly drivable buffer
picking up the products to be loaded with the buffer system during or in anticipation of an overload in the destination storage area; and
releasing the products to be loaded again to the destination storage area after an overload or after the end of the risk of an overload.

2. A process in accordance with claim 1, wherein the buffering system picks up the products to be loaded during or in anticipation of an overload in the destination storage area fully automatically or at least partly automatically in an ordered and defined manner and again releases same fully or at least partly automatically in a defined manner to the destination storage area corresponding to the selected logistic feeding strategy.

3. A process in accordance with claim 1, further comprising:
providing a decision station arranged in the feed section; and
assigning the products to be loaded to the buffering system, with the decision station, during or in anticipation of an overload of the destination storage area.

4. A process in accordance with claim 1, wherein the product to be loaded is palletized in a palletizing/depalletizing station before being picked up in the buffer of the buffering system and is again depalletized after buffering in the buffer before being released to the destination storage area.

5. A process in accordance with claim 4, wherein in case of a load-specific storage capacity, i.e., in case of sufficient storage capacity of the destination storage area, the product to be loaded being buffered at the buffer is fed automatically to the destination storage area via the depalletizing system of buffering system.

6. A process in accordance with claim 3, that wherein a higher-level control and warehouse management system operates or actuates the decision station as an executing mechanism.

7. A process in accordance with claim 1, wherein the decision station recognizes the product to be loaded by tracking the product to be loaded or container or by identification on the basis of the load of the destination storage area.

8. A process in accordance with claim 1, further comprising:
providing a decision station; and
feeding from the buffering system to the destination storage area, during which selection of products to be loaded, which are needed in a prioritized manner, is still made possible via the decision station arranged downstream.

9. A process in accordance with claim 1, wherein a priority product to be loaded, which is needed in a prioritized manner, is recognized already at the decision station and is fed directly to the destination storage area.

10. A storage system for products to be loaded, in a commissioning unit, with feeding of the products to be loaded, the system comprising:
a feed station;
a destination storage area or to a storage area storage and retrieval unit of the destination storage area or a commissioning unit high-shelf storage area;
a feed section for feeding products to be loaded, in the form of packing drums, containers, boxes, individually packed and/or bundled products, from the feed station to the destination storage area or to a storage area storage and retrieval unit of the destination storage area or a commissioning unit high-shelf storage area;
a buffering system with a reversibly drivable buffer, the buffering system for picking up the products to be loaded with the buffer system during or in anticipation of an overload in the destination storage area; and releasing the products to be loaded again to the destination storage area after an overload or after the end of the risk of an overload.

11. A storage system in accordance with claim 10, wherein the buffer is a horizontal, linear or closed buffering section arranged close to the floor or overhead or an accumulating roller conveyor.

12. A storage system in accordance with claim 10, wherein the buffer is a reversible vertical conveyor, a circulating paternoster or a reversible spiral conveyor.

13. A storage system in accordance with claim 10, wherein the buffering system is designed for stackable products to be loaded.

14. A storage system in accordance with claim 13, wherein the buffering system has a palletizing and depalletizing system, which can be operated via an articulated-arm robot or a layer palletizer.

15. A storage system in accordance with claim 14, wherein the layer palletizer comprises an empty pallet magazine, a palletizing/depalletizing unit and empty pallet buffering sections.

16. A storage system in accordance with claim 10, wherein the buffering system is connected to the feed section via a reversible conveying section or via two non-reversible, preferably parallel conveying sections.

17. A storage system in accordance with claim 16, further comprising a decision station wherein the conveying section is connected to the decision station and is intended for removing products to be loaded to the buffering system.

18. A storage system in accordance with claim 17, wherein one of the conveying sections opens into the feed section after the decision station for returning the buffered products to be loaded to the destination storage area.

19. A storage system in accordance with claim 10, wherein the destination storage area is a high-shelf storage area, a rotary storage unit or a freely displaceable or rail-borne storage area storage and retrieval unit or bay storage and retrieval unit preferably for the high-shelf storage area/rotary storage unit, and the feed station of the feed section is the goods receiving area of the storage system, at which the product to be loaded is delivered via trucks.

20. A storage system in accordance with claim 10, wherein the destination storage area is a shipping warehouse, and the buffering system acts as a shipping buffer in case of out-of-balance load between different shipping areas.
